(19) United States
(12) Patent Application Publication
(10) Pub. No.: US 2013/0260444 A1
(43) Pub. Date: Oct. 3, 2013

(54) BIOCHEMICAL PROCESS FOR SELENIUM RECOVERY FROM BIOREMEDIATION EFFLUENT OR SLUDGE

(71) Applicants: Yan Jin, Shanghai (CN); Weiqing Xu, Shanghai (CN); Yan Huang, San Diego, CA (US)

(72) Inventors: Yan Jin, Shanghai (CN); Weiqing Xu, Shanghai (CN); Yan Huang, San Diego, CA (US)

(21) Appl. No.: 13/254,993

(22) PCT Filed: Dec. 17, 2010
(86) PCT No.: PCT/CN10/02068

§ 371 Date: Sep. 6, 2011

(51) Int. Cl. C01B 19/00

(52) U.S. Cl. CPC C01B 19/00
USPC 435/267

(57) ABSTRACT

Wastewater containing selenium in a soluble form is treated in a bioreactor. Microorganisms in the reactor reduce the selenium to elemental selenium, which is insoluble. The elemental selenium is discharged from the reactor in waste sludge. The waste sludge is thickened and then treated with a cell lysis reagent to break down or dissolve micro-organism cells in the sludge. After lysis, the sludge is treated to physically separate out the remaining solids, which includes elemental selenium, for reuse.

### FIELD

This specification relates to wastewater treatment to remove selenium or other elements and to the recovery of selenium or other elements from a bioremediation effluent or sludge.

### BACKGROUND

The following paragraphs are not an admission that any of the information below is common general knowledge or citable as prior art.

Selenium is a trace element essential for human health. Selenium is also a precious non-metal with several useful properties. For example, selenium has photovoltaic and conductive properties making it useful in photovoltaic and electronic products. Selenium is also used as a pigment in glass and in vitamin supplements and fertilizer.

However, selenium becomes toxic at very low concentrations. Selenium accumulates in the bodies or plants and fish that live in selenium-contaminated water and in the bodies of wildlife and people that eat those plants and fish. In people, elevated selenium concentrations may cause neurological damage and hair and nail loss.

Selenium may be present in soluble forms (selenate and selenite) in wastewater produced by various industrial or agricultural operations. For example, selenium is often present in flue gas desulphurization blowdown water produced in coal fired power plants. Selenium can also be present in some oil refining and mining wastes. Discharge limits for selenium may be set at between 10 parts per billion (ppb) and 50 ppb of water.

International Publication No. WO 2007/012181 describes a biological reactor for removing selenium from wastewater. Selenium removing reactors are sold by GE Water and Process Technologies, a business within the General Electric Company, under the ABMet trade mark. In these reactors, a fixed media bed supports a biofilm of selenium reducing organisms. Selenate and selenite in the wastewater are reduced by the organisms to an insoluble form of selenium, typically elemental selenium, which precipitates from the wastewater. The selenium is retained in the reactor until it is removed in a waste sludge by a flushing or backwashing operation.

### SUMMARY

The following summary is intended to introduce the reader to the detailed description to follow and not to limit or define any claimed invention.

The sludge or effluent removed from a selenium bioreactor may contain biomass, elemental selenium, and various other solids. The sludge or effluent may be classified as a toxic waste and must be stored or disposed of to prevent selenium leaching into the environment. The cost of storing or disposing of the sludge is significant. On the other hand, the selenium in the sludge is a valuable commodity. Accordingly, recovering the selenium from the sludge produces a useable product and reduces a regulatory and environmental problem.

In a process described herein, a sludge or effluent containing elemental selenium is treated to recover the selenium. The biomass in the sludge or effluent is made soluble with cell lysis reagents, optionally comprising enzymes. The elemental selenium remains insoluble and is separated from the sludge or effluent, for example by centrifugation.

When combined with a bioremediation process, the process provides for recycling or recovery of selenium from waste. The recovered selenium can be used as a resource for industrial applications. Remaining effluent or sludge can be re-used as a nutrient for the bioremediation process, or treated further. The process may also be useful for the recovery of other precious elements that can be contained in an insoluble form in a bioremediation effluent or sludge.

### FIGURES

FIG. 1 is a schematic process flow diagram of a selenium recovery process.

### DETAILED DESCRIPTION

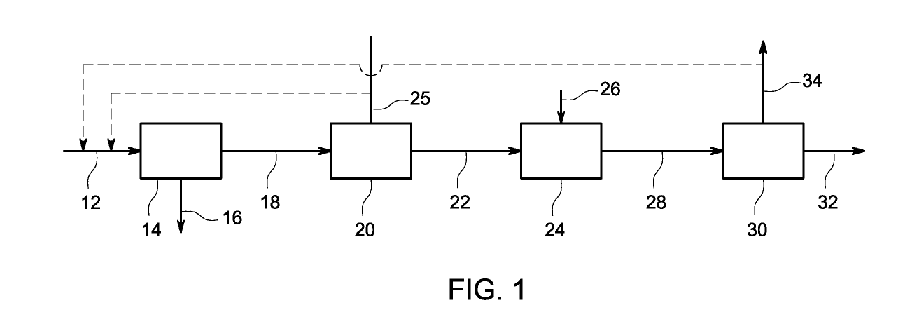

FIG. 1 shows a process 10 for recovering selenium. A feed flow 12 of wastewater containing selenium enters a bioreactor 14. In the bioreactor 14, microorganisms convert soluble forms of selenium into insoluble elemental selenium. The bioreactor 14 may be an ABMet™ reactor available from the General Electric Company. In this type of reactor, water to be treated flows water through a fixed media bed that supports the microorganisms. The elemental selenium is retained with biomass in the bioreactor 14. Treated water 16 flows out of the bioreactor 14, preferably with a selenium concentration reduced to below discharge limits. The bioreactor 14 is periodically flushed or backwashed producing sludge 18, which contains biomass, elemental selenium and various other solids, in particular suspended solids that were present in the feed flow 12. Other bioremediation processes may also produce an effluent or sludge containing selenium. For example, selenium may be removed from wastewater in a membrane bioreactor containing a suspended growth of selenium reducing organisms. Elemental selenium is discharged in a sludge drawn from the bottom of a process tank upstream of or containing a membrane filter, or from a separate membrane vessel.

The sludge 18 is sent to sludge thickening device 20 to produce a thickened, or de-watered, sludge 22. The sludge thickening device 20 may be, for example, a centrifuge or a filter press. Excess water 25 released from the sludge 24 may be sent to a separate wastewater treatment plant or recycled to a point upstream of the bioreactor 14. The thickened sludge typically contains 10-30 wt % solids.

The thickened sludge 22 is sent to a mixing tank 24. One or more cell lysis reagents or buffers 26 are added to the mixing tank 24 and mixed with the thickened sludge 22. The cell lysis reagent 26 disintegrates the cells of the microorganism, which frees elemental selenium particles from association with the cells. Some or all of the cells may be made soluble and dissolved in water remaining in the thickened sludge 22. Some of the cells may be merely broken down into small particles no longer part of a liquid filled intact cell. The reagent 26 may be, for example, sodium dodecyl sulfate (SDS) available form various suppliers such as Millipore. Optionally, the reagent might include an enzyme such as lysozyme. Commercially available cell lysis buffers, for example as sold by Promega or Sigma, having a mixture of reagents may also be used. The reaction in the mixing tank may occur under ambient or generally neutral pH conditions. Generally clean water may be added if required or desirable to enhanced the break up or dissolution of the cells. Alternatively, the cells of the microorganism can be disintegrated by mechanical lysis, for example using ultrasonic waves, or by a combination of chemical and mechanical methods.

A lysed sludge 28 is removed from the mixing tank 24 and sent to a physical separation unit 30. The separation unit 30 may operate based on either the particle size or density, or both, of the selenium particles relative to other solids or liquids in the lysed sludge 28. For example, the separation unit 30 may be a filter or a centrifuge, or both, with one or multiple stages. A solids portion 32 contains an increased concentration of elemental selenium is removed form the centrate or filtrate side of the separation unit 30. The solids portion 32 may be processed further, for example by drying, as required for re-use in industry. A liquids portion 34 has a reduced selenium concentration but is rich in organic matter. The liquids portion 34 may be sent to a separate wastewater treatment plant or to a point upstream of the bioreactor 14. The lysed cells in the liquids portion 34 may supply nutrients to the bioreactor 14.

By combining a selenium recovery process with the bioreactor process, selenium is recycled from wastewater. The recovered selenium is a valuable resource for industrial applications. The lysed organisms can be reused as a source of nutrients to enhance activity in the bioreactor. The total amount of selenium present in waste products is reduced. The recovery process may also be applicable to the recovery of other precious elements, such as palladium or tellurium, which can be produced in an insoluble form in a bioremediation effluent or sludge.

### EXAMPLE

A sample of sludge was collected from an ABMet bioreactor treating flue gas desulphurization blowdown water. The solids portion of the thickened sludge pellet was about 49% biomass, 1% elemental selenium and 50% other previously suspended solids.

A test was done to determine if a cell lysis reagent would be effective in making biomass remain in the supernatant of a centrifuge. Bioreactor sludge without selenium was centrifuged at not higher than 4400 g for 5 min. The supernatant was mainly water and pellets including biomass were separated from the supernatant. The pellets were re-suspended in a solution containing a cell lysis reagent and incubated at room temperature for 10 to 15. The reagent used in the test was a commercial cell lysis reagent, Nuclei Lysis Solution sold by Promega (Catalogue Number A7943). In various samples, the biomass was re-suspended at concentrations ranging from 5.2e7 colony formation units per milliliter (cfu/ml) to 5.2e8 cfu/ml. No obvious biomass pellet was visible after these samples were centrifuged again at 4400 g and 5 minutes. These tests indicated that the biomass could be treated sufficiently to not be collected with solids in a centrifuge.

To test the feasibility of separating elemental selenium from lysed biomass, elemental selenium was added to samples as described above and mixed to form a suspension. The samples were then centrifuged at up to 4400 g for five minutes. The elemental selenium was recovered as a bright red pellet from the centrifuge.

1. A process for recovering an insoluble element such as selenium, a rare earth or a heavy metal from a bioremediation sludge or effluent, the sludge or effluent comprising the insoluble element and microorganisms capable of reducing soluble forms of the insoluble element, the process comprising steps of,
a) mixing a cell lysis reagent into the sludge or effluent;
b) physically separating particles of the insoluble element from lysed cells of the sludge or effluent.

2. The process of claim 1 wherein the cell lysis reagent comprises an enzyme.

3. The process of claim 1 wherein the sludge or effluent is maintained generally at its ambient pH during step a).

4. The process of claim 1 wherein step b) comprises passing the sludge or effluent through a centrifuge.

5. A process for treating a wastewater comprising soluble forms of selenium comprising the steps of,
a) treating the wastewater in a bioreactor containing selenium reducing microorganisms;
b) withdrawing a sludge comprising particles of elemental selenium and microorganisms from the reactor;
c) disintegrating cells of the microorganisms; and,
d) passing the sludge through a solid-liquid separation device to remove at least some of the particles of elemental selenium from the remainder of the sludge.

6. The process of claim 5 wherein at least a portion of the sludge remaining after step d) is recycled to, or upstream of, the bioreactor.

7. The process of claim 5 wherein step c) comprises adding a cell lysis reagent to the sludge.

8. The process of claim 7 wherein the cell lysis reagent comprises an enzyme.

9. The process of claim 7 wherein step c) occurs at about the ambient pH of the sludge.

10. The process of claim 5 wherein step d) comprises passing the sludge through a centrifuge.

11. The process of claim 5 wherein step a) comprises flowing the wastewater through a fixed media bed and step b) comprises flushing or backwashing the media bed.
